(19) United States
(12) Patent Application Publication
(10) Pub. No.: US 2010/0155175 A1
(43) Pub. Date: Jun. 24, 2010

(54) Worldwide Escape Systems

(76) Inventor: William R. Hafner, Huntingdon Valley, PA (US)

Correspondence Address: RUTH EURE, 4795 EDISON AVENUE, BOULDER, CO, 80301, US

(21) Appl. No.: 12/655,017

(22) Filed: Dec. 22, 2009

Related U.S. Application Data
(60) Provisional application No. 61/203,459, filed on Dec. 22, 2008.

(51) Int. Cl. A62B 1/00; A62B 35/00

(52) U.S. Cl. 182/4; 182/3

(57) ABSTRACT

The Worldwide Escape Systems is designed for use as a fire escape for occupants of multistory buildings. The Worldwide Escape Systems comprises sturdy ropes and body harnesses. The ropes and harnesses are coated with highly stable, organo-mineral polymers, a new kind of silicate material which is fire resistant This polymer, officially designated as Quaternary Ammonium Silicates (QAS), also has outstanding heat dissipation characteristics.

### CLAIM OF PRIORITY

This patent application claims priority under 35 USC 119(e)(1) from U.S. Provisional Patent Application Ser. No. 61/203,459 filed Dec. 22, 2008, of common inventorship herewith entitled, “Worldwide Escape Systems.”

### FIELD OF THE INVENTION

The present invention pertains to the field of fire escape systems, and more specifically to fire escape systems for multi-story buildings.

### BACKGROUND OF THE INVENTION

The prior art has put forth several designs for fire escape systems. Among these are:

U.S. Pat. No. 4,640,388 to Walborn describes an escape device comprising roller spools for cables positioned near windows.

U.S. Pat. No. 4,703,831 to Forrest et al describes a fire escape apparatus for use in multi-story buildings comprising a movable rope system and expansion means for extending an arm outward from an anchor.

U.S. Pat. No. 7,195,100 to Shechter describes a system and method for an escapable multi-story building comprising a series of brackets and cables.

None of these references describe the present invention.

### SUMMARY OF THE INVENTION

It is an object of the present invention to provide an improved escape system for escape from a multi-story building.

### BRIEF DESCRIPTION OF THE DRAWINGS

FIG. 1 shows a building equipped with the escape system of the present invention.

FIG. 2 shows a close-up of the building equipped with the escape system of the present invention.

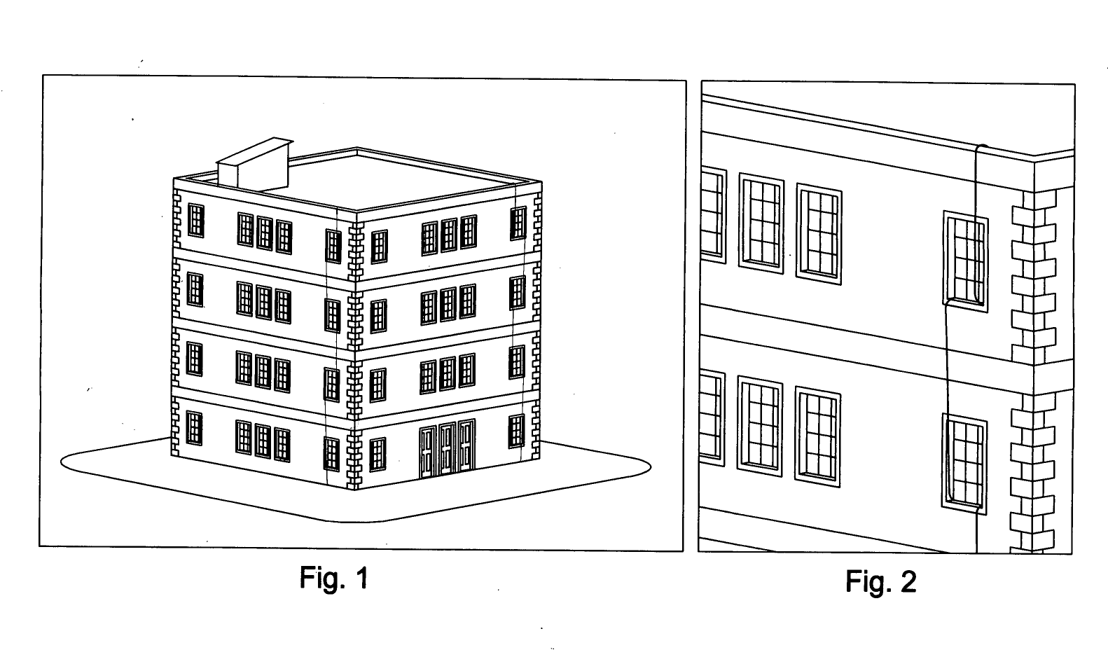

### DETAILED DESCRIPTION OF THE INVENTION

The present invention, hereinafter referred to as The Worldwide Escape Systems is designed for use as a fire escape for occupants of multistory buildings. The Worldwide Escape Systems comprises sturdy ropes and body harnesses. The ropes and harnesses are coated with highly stable, organo-mineral polymers, a new kind of silicate material which is fire resistant This polymer, officially designated as Quaternary Ammonium Silicates (QAS), also has outstanding heat dissipation characteristics. The number of ropes and placement thereof and body harnesses will be determined by the height and physical configuration of the building the Worldwide Escape Systems is to be installed on. Sturdy mounting hardware is supplied with the Worldwide Escape Systems that is used to attach the individual escape ropes to a building.

At a minimum, a fire escape rope is attached to the rooftop, at each corner and to windows directly below the rooftop ropes, on each floor. The number of ropes and harnesses used is increased for larger structures to accommodate the additional number of individuals that live or work on each floor.

It should be understood that the application of the system of the present invention to any particular structure is flexible so that any size and strength of rope or cable can be considered to meet the needs of the situation. The storage of the rope or cable is convenient such that the rope or cable can be stored inside the building when not in use. For example, the rope or cable can generally be stored below the window or in close proximity where it is anchored to the wall or floor and rolled up and kept along with the other body harnesses and rappel equipment in a cabinet which can be locked or secured from tampering or outside weather wear and brought out for use when needed. The equipment can be inspected periodically for good condition and the storage such that it blends in with the building design and interior. Also, keep in mind that although this invention is intended primarily for fire escape, this system can also be used during residential break-ins to avoid being trapped and subjected to possible bodily harm.

In an alternative embodiment, the system of the present invention is especially useful in large applications or buildings comprising an additional rope or cable or use the existing rope or cable to recycle or send back up harnesses that had been used to let people down and therefore provide enough harnesses for people in an upper level if not enough harnesses had been provided.

In a further alternative embodiment, a safety feature such as a knot or metal fitted anchor can be attached near the lower end of the rope to prevent someone from slipping off the end of the rope.

In a further alternative embodiment, another safety feature can be the window sill where the rope hangs over can be rounded to prevent the rope from fraying as might happen on a window sill having a sharp edge possibly causing the rope to become worn and break or fail.

In a further alternative embodiment, another feature of this system is that the harness used could include a provision or adaptation such as additional straps to allow an adult to carry a child or pet with them as they exit the building using the system. This may be most useful in residential applications such as homes or apartments.

The use of the Worldwide Escape Systems is very straightforward. In the event of a fire or other type of emergency that required immediate evacuation, individuals proceed to the rooftop or to windows on each floor that are marked as fire escape exits. The body harnesses are then donned and the escape rope firmly grasped. After this has been completed, individuals exit through the window and rappel down the exterior wall until reaching ground level or a floor where it was safe to exit. The Worldwide Escape Systems is an effective and practical fire escape system for multistory buildings that can be, quite literally, a life saver in the event of a disastrous fire.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A fire escape system, comprising:
sturdy ropes and body harnesses, wherein the ropes and harnesses are coated with Quaternary Ammonium Silicates (QAS);
sturdy mounting hardware to attach the individual escape ropes to a building.

2. The fire escape system of claim 1, wherein a multiplicity of ropes is installed, so that a rope is attached to the rooftop at each corner and to windows directly below the rooftop on each floor.

3. The fire escape system of claim 1, further including a storage cabinet so the ropes and harnesses can be stored inside the building when not in use.

4. The fire escape system of claim 3 wherein the rope or cable is stored below the window or in close proximity where it is anchored to the wall or floor and rolled up and kept along with the other body harnesses and rappel equipment in a lockable cabinet.

5. The fire escape system of claim 1 comprising an additional rope or cable or use the existing rope or cable to recycle or send back up harnesses that had been used to let people down and therefore provide enough harnesses for people in an upper level if not enough harnesses had been provided.

6. The fire escape system of claim 1 further comprising a knot or metal fitted anchor attached near the lower end of the rope to prevent someone from slipping off the end of the rope.

7. The fire escape system of claim 1 further including a rounded edge on the window sill over which the rope hangs to prevent the rope from fraying.

8. The fire escape system of claim 1 further including an additional strap to allow an adult to carry a child or pet with them as they exit the building using the system.

9. The fire escape system of claim 1 further including a multiplicity of additional straps to allow an adult to carry a child or pet with them as they exit the building using the system.
